(19) United States
(12) Patent Application Publication
(10) Pub. No.: US 2013/0227102 A1
(43) Pub. Date: Aug. 29, 2013

(54) Chunk Request Scheduler for HTTP Adaptive Streaming

(71) Applicants: Andre Beck, Batavia, IL (US); Jairo O. Esteban, Freehold, NJ (US); Steven A. Benno, Towaco, NJ (US); Volker F. Hilt, Hegnach (DE); Ivica Rimac, Remseck (DE)

(72) Inventors: Andre Beck, Batavia, IL (US); Jairo O. Esteban, Freehold, NJ (US); Steven A. Benno, Towaco, NJ (US); Volker F. Hilt, Hegnach (DE); Ivica Rimac, Remseck (DE)

(73) Assignee: Alcatel-Lucent USA Inc, Murray Hill, NJ (US)

(21) Appl. No.: 13/408,014

(22) Filed: Feb. 29, 2012

(51) Int. Cl. G06F 15/16

(52) U.S. Cl. 709/223; 709/224

(57) ABSTRACT

A chunk request scheduler is provided for HTTP adaptive streaming. Requests for media chunks are scheduled over a network by requesting the media chunks over at least one connection; storing the media chunks in at least one buffer; monitoring a level of the at least one buffer; and selectively switching between at least two predefined download strategies for the request based on the buffer level. Requests for media chunks can also be scheduled over a network by obtaining an ordering of the connections based on a rate of each connection; storing the media chunks in at least one buffer; and requesting the media chunks over the ordered plurality of connections based on a size of the media chunks. For example, audio chunk requests can be scheduled over TCP connections having a lower rate order and video chunk requests can be scheduled over TCP connections having a higher rate order.

### FIELD OF THE INVENTION

The present invention relates generally to adaptive streaming techniques, and more particularly to techniques for requesting chunks for adaptive streaming applications.

### BACKGROUND OF THE INVENTION

HTTP (Hypertext Transfer Protocol) Adaptive Streaming is a technique used to stream multimedia over a computer network, such as a computer network employing TCP (Transmission Control Protocol) connections. Current HTTP Adaptive Streaming client implementations may not fully utilize the available throughput of TCP connections. Thus, the client may select a bandwidth level for a given TCP connection that is lower than necessary (in turn leading to a reduced video quality). For each TCP connection, a “congestion window” limits the total number of unacknowledged packets that may be in transit. The size of the congestion window is determined by a “slow start” phase (also referred to as an exponential growth phase) and a “congestion avoidance” phase (also referred to as a linear growth phase).

During the exponential growth phase, the slow start mechanism increases the size of the congestion window each time an acknowledgment is received. The window size is increased by the number of segments that are acknowledged. The window size is increased until either an acknowledgment is not received for a given segment (e.g., a segment is lost) or a predetermined threshold value is reached. If a segment is lost, TCP assumes that the loss is due to network congestion and attempts to reduce the load on the network. Once a loss event has occurred (or the threshold has been reached), TCP enters the linear growth phase. During the linear growth phase, the window is increased by one segment for each round trip time (RTT), until a loss event occurs.

Microsoft Silverlight™ is an application framework for writing and running Internet applications. The HTTP Adaptive Streaming client, for example, within Microsoft Silverlight opens two persistent TCP connections at the beginning of a streaming session. The client uses both connections to request audio and video chunks, sometimes simultaneously. The client may switch between the two connections to request either audio or video chunks. A new chunk is not requested until the client has fully received the previously requested chunk. The client may also introduce gaps in between chunk requests in order to prevent its internal buffer from overflowing. Thus, the HTTP Adaptive Streaming client within Microsoft Silverlight may not fully utilize the available throughput because of undesired interactions at the TCP layer that lead to “TCP Slow Start” or “TCP Congestion Avoidance” (or both).

A need therefore exists for a mechanism to increase the data throughput between an HTTP Adaptive Streaming client and server.

### SUMMARY OF THE INVENTION

Generally, a chunk request scheduler is provided for HTTP adaptive streaming. According to one aspect of the invention, requests for media chunks (e.g., audio and/or video chunks) are scheduled over a network by requesting the media chunks over the network using at least one connection; storing the media chunks in at least one buffer; monitoring a level of the at least one buffer; and selectively switching between at least two predefined download strategies for the requesting step based on the buffer level.

A number of exemplary download strategies are addressed. For example, the chunk request scheduler can switch between a download strategy of scheduling audio and video chunk requests over multiple TCP connections and a download strategy of scheduling audio and video chunk requests over a single TCP connection. In addition, the chunk request scheduler can switch between a download strategy of pipelining multiple audio and video chunk requests over a single TCP connection and a download strategy of pipelining single audio and video chunk requests over a single TCP connection.

In yet another variation, the chunk request scheduler can switch between a download strategy of pipelining multiple audio and video chunk requests over a single TCP connection and a download strategy of sequentially scheduling audio and video chunk requests over a single TCP connection. In addition, the chunk request scheduler can switch between a download strategy of requesting audio and video chunk requests over one or more TCP connections and a download strategy of waiting to schedule N chunk requests until a predefined lower buffer threshold is satisfied.

According to another aspect of the invention, requests for media chunks (e.g., audio and/or video chunks) are scheduled over a network by obtaining an ordering of the plurality of connections based on a rate of each of the plurality of connections; storing the media chunks in at least one buffer; and requesting the media chunks over the ordered plurality of connections based on a size of the media chunks. For example, audio chunk requests can be scheduled over or more TCP connections having a lower rate order and video chunk requests can be scheduled over TCP connections having a higher rate order.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIGS. 2 through 7 are flow charts describing exemplary implementations for the Chunk Request Scheduler of FIG. 1; and

FIG. 8 is a block diagram of an end user device of FIG. 1 that can implement the processes of the present invention.

### DETAILED DESCRIPTION

FIG. 1 illustrates an exemplary network environment 100 in which the present invention can operate. Aspects of the invention provide a mechanism to increase the data throughput between an HTTP Adaptive Streaming client 120 and a server 180. As shown in FIG. 1, an end user 110 employs the HTTP Adaptive Streaming client 120 to access a streamed media object from the server 180. The exemplary network environment 100 may be comprised of any combination of public or proprietary networks, including the Internet, the Public Switched Telephone Network (PSTN), a cable network, and/or a wireless network, including a cellular telephone network, the wireless Web and a digital satellite network.

According to one aspect of the invention, data throughput between the HTTP Adaptive Streaming client 120 and the server 180 is increased through efficient scheduling of chunk downloads over one or more TCP connections through the network 100. As a result, the HTTP Adaptive Streaming client 120 may be able to select a higher video quality level or reduce the number of quality oscillations during the video playback.

According to another aspect of the invention, a Chunk Request Scheduler 130 is provided for HTTP Adaptive Streaming clients 120. The disclosed Chunk Request Scheduler 130 improves the scheduling of audio and video chunk requests over one or more TCP connections. The Chunk Request Scheduler 130 opens and maintains one or more TCP connections between the HTTP Adaptive Streaming client 120 and server 180. The Chunk Request Scheduler 130 accepts requests for audio and video chunks from the HTTP Adaptive Streaming client 120 and schedules them over the opened TCP connections. The Chunk Request Scheduler 130 can optionally be integrated with the HTTP Adaptive Streaming client 120 in order to have access to internal variables, such as those related to the rate determination algorithm of the HTTP Adaptive Streaming client 120.

As discussed hereinafter, the exemplary Chunk Request Scheduler 130 may follow different scheduling strategies to maximize the data throughput between the server 180 and the client 120. In one exemplary embodiment, the Chunk Request Scheduler 130 can dynamically switch between a plurality of strategies, for example, based on observed network conditions.

The exemplary adaptive streaming client 120 typically employs one or more buffers 140 to store downloaded chunks, in a known manner.

The exemplary adaptive streaming client 120 may be implemented as a media player executing, for example, on a general purpose computer. The media player may be implemented, for example, using the Microsoft Silverlight™ application framework, as modified herein to provide the features and functions of the present invention. In an alternate implementation, the exemplary adaptive streaming client 120 may be implemented as a media player executing, for example, on dedicated hardware, such as a set-top terminal (STT).

### Chunk Scheduling Strategies

The exemplary Chunk Request Scheduler 130 may pursue any of the following scheduling strategies below (or a combination thereof):

Interleaving Video and Audio Chunk Requests

The Chunk Request Scheduler 130 can optionally interleave video and audio chunk requests by inserting audio chunk requests in between video chunk request such that any gap that the client 120 would otherwise introduce in between video chunk requests is filled by one or more audio chunk requests.

Pipelining Chunk Requests

The Chunk Request Scheduler 130 can optionally pipeline chunk requests by scheduling chunk requests back-to-back such that there is always at least one outstanding chunk request.

Sending Chunk Requests Over Multiple Connections

The Chunk Request Scheduler 130 can optionally open several TCP connections and simultaneously sends chunk requests (or requests for partial chunks) over multiple connections in order to reduce the impact of TCP congestion events on any single TCP connection during a chunk download. This strategy may also help in cases where the initial TCP receive window is set to a small value.

Chunk Request Scheduler Implementations

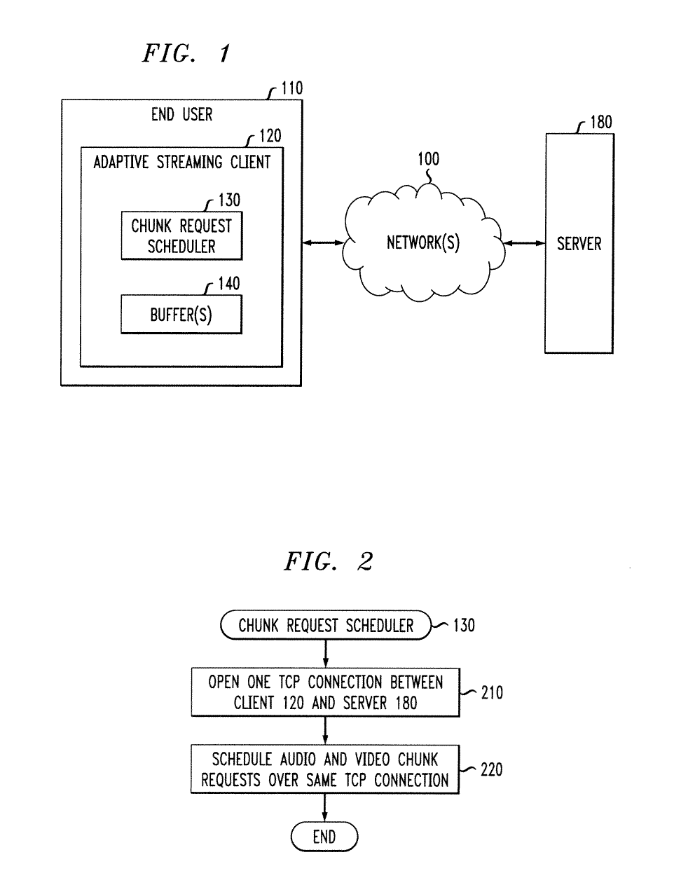

FIGS. 2 through 6 are flow charts describing exemplary implementations for the Chunk Request Scheduler 130. It is noted that a given implementation of the Chunk Request Scheduler 130 can optionally incorporate functionality from some or all of the embodiments disclosed in FIGS. 2 through 6, and dynamically switch between a plurality of strategies, for example, based on observed network conditions.

FIG. 2 is a flow chart describing a first exemplary implementation for the Chunk Request Scheduler 130. In the embodiment of FIG. 2, the exemplary Chunk Request Scheduler 130 opens one TCP connection between the client 120 and the server 180 during step 210 and schedules audio and video chunk requests over the same TCP connection during step 220 so that any idle time between chunk downloads is minimized. It is noted that idle time between chunk downloads may otherwise cause TCP to go into “Slow Start” or lead to bursty traffic and subsequent packet losses at the beginning of the next chunk download.

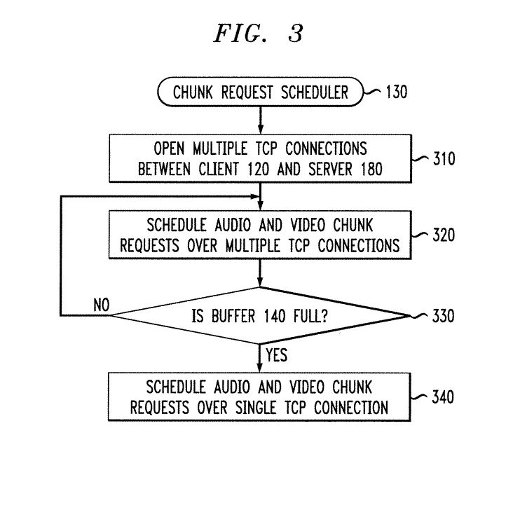

FIG. 3 is a flow chart describing a second exemplary implementation for the Chunk Request Scheduler 130. In the embodiment of FIG. 3, the exemplary Chunk Request Scheduler 130 initially opens several TCP connections during step 310 and schedules audio and video chunk requests over the multiple TCP connections during step 320 to download chunks as the buffer 140 employed by the HTTP Adaptive Streaming client 120 is being filled. During the buffer-filling phase, chunks are typically requested as quickly as possible and there are no gaps between chunk downloads. Opening multiple TCP connections helps if the initial TCP receive window is small and also reduces the impact of any TCP congestion event on any TCP connection during a chunk download.

A test is performed during step 330 to determine if the buffer 140 is full. If it is determined during step 330 that the buffer 140 is full, then the Chunk Request Scheduler 130 switches to using a single TCP connection during step 340 and starts interleaving requests for audio and video chunks in order to minimize request gaps. If, however, it is determined during step 330 that the buffer 140 is not full, then the Chunk Request Scheduler 130 continues to schedule audio and video chunk requests over multiple TCP connections during step 320, until the buffer is full.

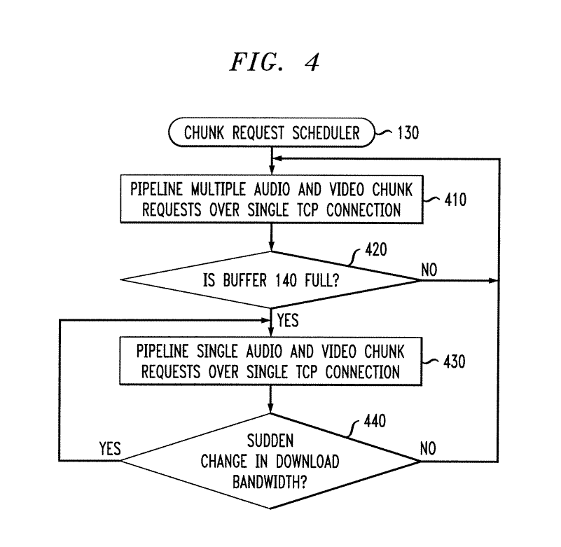

FIG. 4 is a flow chart describing a third exemplary implementation for the Chunk Request Scheduler 130. In the embodiment of FIG. 4, the exemplary Chunk Request Scheduler 130 initially pipelines multiple audio and video chunk requests over a single connection during step 410 in order to maximize the data throughput. As used herein, the term “multiple audio and video chunk requests” indicates that multiple outstanding audio chunk requests and/or multiple outstanding video chunk requests are permitted at a given time. It is noted that pipelining comes at the expense of a slower reaction time to changes in the download bandwidth.

A test is performed during step 420 to determine if the buffer 140 is full. If it is determined during step 420 that the buffer 140 is not full, then the exemplary Chunk Request Scheduler 130 continues to pipeline multiple audio and video chunk requests over a single connection during step 410 until the buffer 140 is full.

If, however, it is determined during step 420 that the buffer 140 is full, then the Chunk Request Scheduler 130 pipelines single audio and video chunk requests over a single connection during step 430. In this manner, the Chunk Request Scheduler 130 can interleave audio and video chunk requests, but multiple outstanding audio chunk requests or multiple outstanding video chunk requests are not permitted at a given time.

A further test is performed during step 440 to determine if there is a sudden change in the download bandwidth (either up or down). Generally, when multiple chunk requests are pipelined, it reduces the client's reaction time to changes in bandwidth. As long as the bandwidth is slowly varying, it is not a problem but if there are sudden changes, it is advantageous to switch to single chunk requests so that the client can react faster to the changes. It is more important that the client do it when there is a drop in bandwidth so that its buffer isn't starved, but the strategy can also be applied when conditions improve to allow faster increases in bit rate.

If it is determined during step 440 that there is a sudden change in the download bandwidth, then the Chunk Request Scheduler 130 continues to pipeline single audio and video chunk requests over a single connection during step 430. If, however, it is determined during step 440 that there is not a sudden change in the download bandwidth, then the Chunk Request Scheduler 130 returns to pipelining multiple audio and video chunk requests over a single connection during step 410.

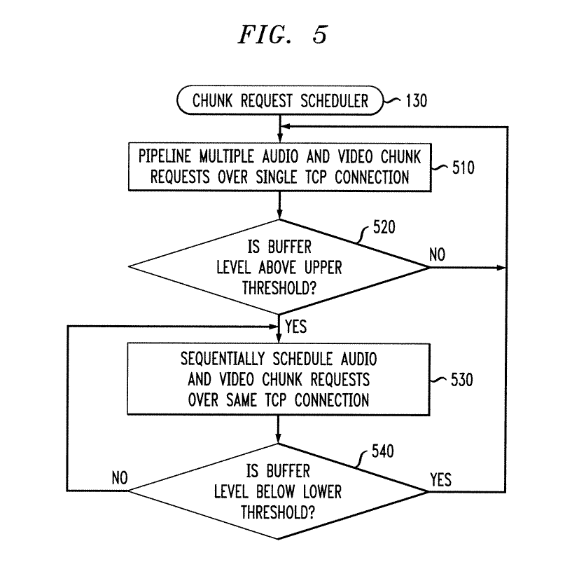

FIG. 5 is a flow chart describing a fourth exemplary implementation for the Chunk Request Scheduler 130. In the embodiment of FIG. 5, the exemplary Chunk Request Scheduler 130 selectively switches between pipelining and sequential chunk requests based on an upper threshold and a lower threshold. The thresholds can be chosen heuristically, for example, to balance the tradeoff between fast reaction time and efficient downloads. Generally, the exemplary Chunk Request Scheduler 130 pipelines multiple chunk requests until the buffer is nearly full to minimize idle time, and then after the buffer is nearly full, the exemplary Chunk Request Scheduler 130 slows down the requests using sequential chunk requests until the buffer level is reduced to the lower threshold.

Generally, as long as the average time for downloading the chunks equals the fixed playout time of the chunk, the pipelining method will eliminate all gaps. However, if the average chunk download time is smaller than the chunk playout time (and the client buffer 140 is of limited size), pipelining will enter a self-clocking regime. More precisely, when the client buffer 140 is full, the next request has to wait until a chunk in the client buffer has been consumed to allow for more data to arrive. This might easily lead to the introduction of gaps of similar frequency as without pipelining. In order to avoid the above problem, a hysteresis is introduced to control the pipelining behavior.

As shown in FIG. 5, the exemplary Chunk Request Scheduler 130 initially pipelines multiple audio and video chunk requests over a single connection during step 510 in order to maximize the data throughput. A test is performed during step 520, to determine if the level of buffer 140 is above the upper threshold. If it is determined during step 520 that the level of buffer 140 is not above the upper threshold, then the exemplary Chunk Request Scheduler 130 continues to pipeline multiple audio and video chunk requests over a single connection during step 510 until the buffer 140 reaches the upper threshold.

If, however, it is determined during step 520 that the level of buffer 140 is above the upper threshold, then the exemplary Chunk Request Scheduler 130 switches to sequentially scheduling audio and video chunk requests over the same TCP connection during step 530. A further test is performed during step 540, to determine if the level of buffer 140 is below the lower threshold. If it is determined during step 540 that the level of buffer 140 is not below the lower threshold, then the exemplary Chunk Request Scheduler 130 continues to sequentially schedule audio and video chunk requests over the same TCP connection during step 530.

If it is determined during step 540 that that the level of buffer 140 is below the lower threshold, then the exemplary Chunk Request Scheduler 130 switches back to pipelining multiple audio and video chunk requests over a single connection during step 510 in order to maximize the data throughput.

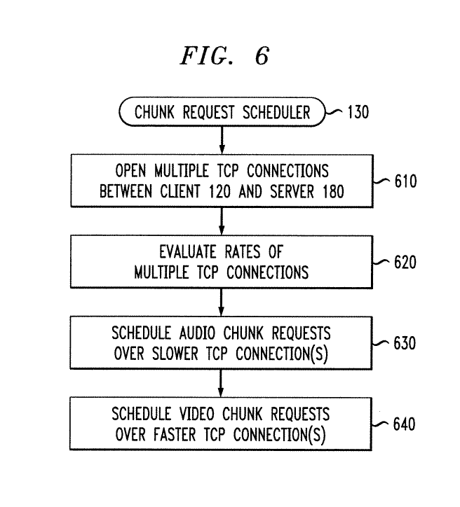

FIG. 6 is a flow chart describing a fifth exemplary implementation for the Chunk Request Scheduler 130. In the embodiment of FIG. 6, the exemplary Chunk Request Scheduler 130 compares rates on concurrent connections and schedules audio chunk requests on the slower connection and video chunk requests on the faster connection.

As shown in FIG. 6, the exemplary Chunk Request Scheduler 130 initially opens multiple TCP connections between the client 120 and the server 180 during step 610. Thereafter, the Chunk Request Scheduler 130 evaluates the rates of the multiple TCP connections during step 620.

The exemplary Chunk Request Scheduler 130 then schedules audio chunk requests over the slower TCP connection(s) during step 630 and schedules video chunk requests over the faster TCP connection(s) during step 640.

Alternatively, the exemplary Chunk Request Scheduler 130 can send requests for smaller chunks on the slower connection(s) during step 630 (to build up the congestion window) and send requests for larger chunks on the faster connection(s) during step 640, as would be apparent to a person of ordinary skill in the art.

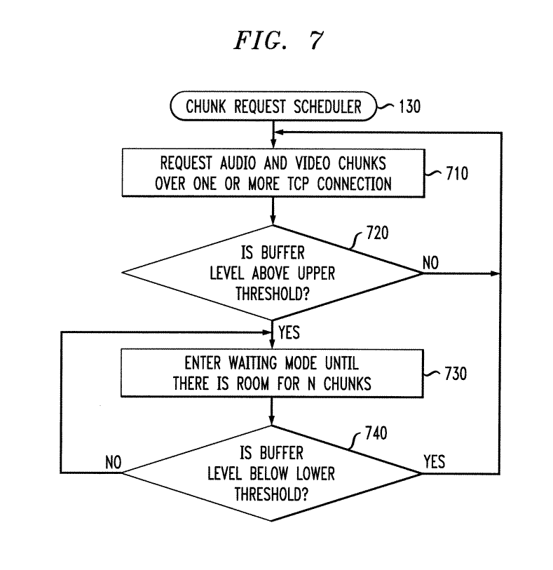

FIG. 7 is a flow chart describing another exemplary implementation for the Chunk Request Scheduler 130. In the embodiment of FIG. 7, the exemplary Chunk Request Scheduler 130 selectively switches between pipelining and sequential chunk requests based on an upper threshold and a lower threshold. The thresholds can be chosen heuristically, for example, to balance the tradeoff between fast reaction time and efficient downloads. Generally, the exemplary Chunk Request Scheduler 130 pipelines multiple chunk requests until the buffer is nearly full to minimize idle time, and then after the buffer is nearly full, the exemplary Chunk Request Scheduler 130 slows down the requests using sequential chunk requests until the buffer level is reduced to the lower threshold.

Generally, as long as the average time for downloading the chunks equals the fixed playout time of the chunk, the pipelining method will eliminate all gaps. However, if the average chunk download time is smaller than the chunk playout time (and the client buffer 140 is of limited size), pipelining will enter a self-clocking regime. More precisely, when the client buffer 140 is full, the next request has to wait until a chunk in the client buffer has been consumed to allow for more data to arrive. This might easily lead to the introduction of gaps of similar frequency as without pipelining. In order to avoid the above problem, a hysteresis is introduced to control the pipelining behavior.

As shown in FIG. 7, the exemplary Chunk Request Scheduler 130 initially requests audio and video chunk requests over one or more connections during step 710 using any of the scheduling strategies described herein. A test is performed during step 720, to determine if the level of buffer 140 is above the upper threshold. If it is determined during step 720 that the level of buffer 140 is not above the upper threshold, then the exemplary Chunk Request Scheduler 130 continues to request audio and video chunks during step 710 until the buffer 140 reaches the upper threshold.

If, however, it is determined during step 720 that the level of buffer 140 is above the upper threshold, then the exemplary Chunk Request Scheduler 130 enters a waiting mode during step 730 until there is room for N chunks (e.g., rather than scheduling each new chunk as each chunk is consumed from the buffer).

A further test is performed during step 740, to determine if the level of buffer 140 is below the lower threshold. If it is determined during step 740 that the level of buffer 140 is not below the lower threshold, then the exemplary Chunk Request Scheduler 130 continues to wait during step 730.

If it is determined during step 740 that that the level of buffer 140 is below the lower threshold, then the exemplary Chunk Request Scheduler 130 switches back to requesting audio and video chunks over one or more connections during step 710, as discussed above. In this manner, the lower threshold specified in step 740 can trigger the exemplary Chunk Request Scheduler 130 to request N chunks at once during step 710 or to pipeline the requests over a single connection.

Conclusion

Among other benefits, aspects of the present invention can help HTTP Adaptive Streaming applications to achieve a higher data throughput between client and server and hence deliver higher quality video to end users.

While FIGS. 2 through 6 show an exemplary sequence of steps, it is also an embodiment of the present invention that the sequences may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by a programmed general-purpose computer, circuit elements or state machines, or in combination of both software and hardware. Such software may be employed in, for example, a hardware device, such as a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

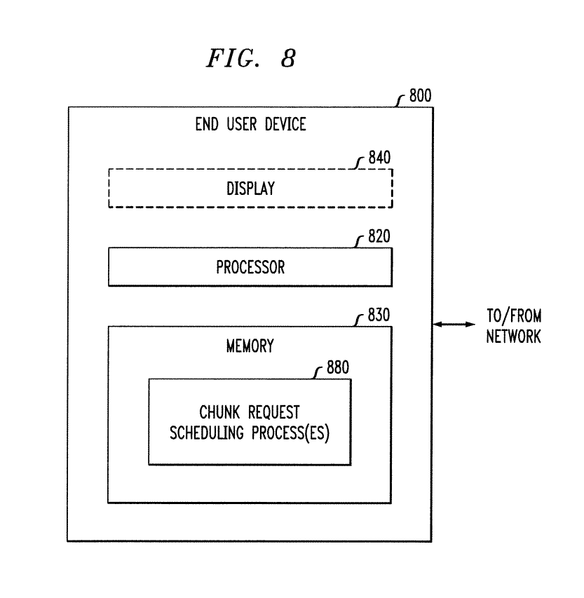

FIG. 8 is a block diagram of an end user device 800 that can implement the processes of the present invention. As shown in FIG. 8, memory 830 configures the processor 820 to implement the chunk request scheduling methods, steps, and functions disclosed herein (collectively, shown as 880 in FIG. 8). The memory 830 could be distributed or local and the processor 820 could be distributed or singular. The memory 830 could be implemented as an electrical, magnetic or optical memory, or any combination of these or other types of storage devices. It should be noted that each distributed processor that makes up processor 820 generally contains its own addressable memory space. It should also be noted that some or all of computer system 200 can be incorporated into a personal computer, laptop computer, handheld computing device, application-specific circuit or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for scheduling requests for media chunks over a network, comprising:
requesting said media chunks over said network using at least one connection;
storing said media chunks in at least one buffer;
monitoring a level of said at least one buffer; and
selectively switching between at least two predefined download strategies for said requesting step based on said buffer level.

2. The method of claim 1, wherein said media chunks comprise one or more of audio and video chunks.

3. The method of claim 1, wherein said at least two predefined download strategies comprise scheduling audio and video chunk requests over multiple TCP connections and scheduling audio and video chunk requests over a single TCP connection.

4. The method of claim 1, wherein said at least two predefined download strategies comprise pipelining multiple audio and video chunk requests over a single TCP connection and pipelining single audio and video chunk requests over a single TCP connection.

5. The method of claim 1, wherein said at least two predefined download strategies comprise pipelining multiple audio and video chunk requests over a single TCP connection and sequentially scheduling audio and video chunk requests over a single TCP connection.

6. The method of claim 1, wherein said at least two predefined download strategies comprise requesting audio and video chunk requests over one or more TCP connections and waiting to schedule N chunk requests until a predefined lower buffer threshold is satisfied.

7. The method of claim 1, wherein said at least two predefined download strategies comprise scheduling audio chunk requests over one or more slower TCP connections and scheduling video chunk requests over one or more faster TCP connections.

8. The method of claim 1, wherein said at least two predefined download strategies comprise scheduling chunk requests below a predefined size threshold over one or more TCP connections below a predefined rate threshold and scheduling chunk requests above a predefined size threshold over one or more TCP connections above a predefined rate threshold.

9. A method for scheduling requests for media chunks over a network having a plurality of connections, comprising:
obtaining an ordering of said plurality of connections based on a rate of each of said plurality of connections;
storing said media chunks in at least one buffer; and
requesting said media chunks over said ordered plurality of connections based on a size of said media chunks.

10. The method of claim 9, wherein said requesting step schedules audio chunk requests over one or more TCP connections having a lower rate order and scheduling video chunk requests over one or more TCP connections having a higher rate order.

11. A system for scheduling requests for media chunks over a network, comprising:
a memory; and
at least one hardware device, coupled to the memory, operative to:
request said media chunks over said network using at least one connection;
store said media chunks in at least one buffer;
monitor a level of said at least one buffer; and
selectively switch between at least two predefined download strategies for said request based on said buffer level.

12. The system of claim 11, wherein said media chunks comprise one or more of audio and video chunks.

13. The system of claim 11, wherein said at least two predefined download strategies comprise scheduling audio and video chunk requests over multiple TCP connections and scheduling audio and video chunk requests over a single TCP connection.

14. The system of claim 11, wherein said at least two predefined download strategies comprise pipelining multiple audio and video chunk requests over a single TCP connection and pipelining single audio and video chunk requests over a single TCP connection.

15. The system of claim 11, wherein said at least two predefined download strategies comprise pipelining multiple audio and video chunk requests over a single TCP connection and sequentially scheduling audio and video chunk requests over a single TCP connection.

16. The system of claim 11, wherein said at least two predefined download strategies comprise requesting audio and video chunk requests over one or more TCP connections and waiting to schedule N chunk requests until a predefined lower buffer threshold is satisfied.

17. The system of claim 11, wherein said at least two predefined download strategies comprise scheduling audio chunk requests over one or more slower TCP connections and scheduling video chunk requests over one or more faster TCP connections.

18. The system of claim 11, wherein said at least two predefined download strategies comprise scheduling chunk requests below a predefined size threshold over one or more TCP connections below a predefined rate threshold and scheduling chunk requests above a predefined size threshold over one or more TCP connections above a predefined rate threshold.

19. A system for scheduling requests for media chunks over a network having a plurality of connections, comprising:
a memory; and
at least one hardware device, coupled to the memory, operative to:
obtain an order of said plurality of connections based on a rate of each of said plurality of connections;
store said media chunks in at least one buffer; and
request said media chunks over said ordered plurality of connections based on a size of said media chunks.

20. The system of claim 19, wherein audio chunk requests are scheduled over one or more TCP connections having a lower rate order and video chunk requests are scheduled over one or more TCP connections having a higher rate order.
